(19) United States
(12) Patent Application Publication
(10) Pub. No.: US 2005/0147742 A1
(43) Pub. Date: Jul. 7, 2005

(54) Processing chamber components, particularly chamber shields, and method of controlling temperature thereof

(75) Inventors: Mark Kleshock, Phoenix, AZ (US); Bruce Gittleman, Scottsdale, AZ (US)

Correspondence Address: WOOD, HERRON & EVANS, LLP, 2700 CAREW TOWER, 441 VINE STREET, CINCINNATI, OH, 45202, US

(73) Assignee: Tokyo Electron Limited

(21) Appl. No.: 10/752,851

(22) Filed: Jan. 7, 2004

(51) Int. Cl. H05H 1/26; B05D 5/12

(52) U.S. Cl. 427/110; 427/446; 428/677; 428/937; 428/685; 118/504

(57) ABSTRACT

A processing chamber component, for example, a removable chamber shield, that has a tendency to expand when exposed to a heat flux, is temperature controlled. The temperature controlled component is particularly useful where exposed to material deposits during processing by PVD, CVD and etching, for example. The component is provided with temperature control properties that avoid high temperatures and temperature gradients as well as large temperature fluctuations. In the case of a chamber shield, the shield may be formed of a base layer typically of a refractory metal such as stainless steel, which has a relatively low thermal conductivity but is mounted in contact with a heat sink, usually at one end thereof such that its other end, which is free, has a tendency to heat and partially cool from processing cycle to processing cycle. The chamber part is provided with a cladding on the base layer of a material of higher thermal conductivity than that of the base layer. The cladding is preferably a Nobel metal, such as gold, silver or copper, but optimally copper, and is applied across at least one side of the base layer and into thermal contact with the heat sink, and extending to the free end of the part. The cladding layer is at least 0.5 millimeters thick, and typically a thickness of about 1 millimeter is sufficient, and is preferably cold sprayed onto the base layer.

This invention relates to the control of the temperature of chamber shields and other components within the chambers of machines for the processing of semiconductor wafers and other substrates, and particularly to the control of particle generation from such components due to thermal changes or cycling.

### BACKGROUND OF THE INVENTION

In semiconductor technology control of particle levels has become crucial to achieving high yields and maximizing profit from the use of processing equipment. With the trend toward smaller and smaller features and more complex devices, a few particles or even a single particle on the surface of a wafer being processed can result in a fatal defect being produced in a device. One chief source for such particles is the contaminating films that are formed on the surfaces of chamber shields and other components of a processing chamber from repeated processing of wafers in the chamber. Such contaminating films adhere to such components only to flake off of the components as the components expand and contract due to thermal changes. Continuous thermal cycling of the components combined with constant buildup of film on the component surfaces produces particles that contaminate the chamber to light upon and damage the devices on the surfaces of substrates being processed within the chambers.

In light of this, it is highly desirable to control both the absolute temperature and thermal excursion of shields and other parts used inside the process module itself. In particular, when the part is exposed to a heat source during processing of a wafer, its temperature rises during the processing and falls during the exchange of wafers. However, in a continual stream of wafer processing, the minimum temperature of the part continues to rise until a steady state is achieved. In a processing module whose function is to deposit a material onto the wafer, stress between the part and material deposited on the part grows as the temperature rises, which often results in flaking of the deposit. Flaking can be caused by the deposit microstructure as well as the thermal expansion mismatch between the part and deposit. Stainless steel is the material of choice for many consumable parts used in semiconductor processing applications because of its ability to be recycled many times, its ability to withstand oxidation, its strength, and the ease of cleaning stainless steel parts.

Although stainless steel is cited as an example, any material, metal or non-metal, that has suitable mechanical properties and is compatible with the processing environment may be used. Stainless steel is a poor thermal conductor. Where it is desired or required that a part be large, control of temperature across the entire part is difficult, even if heat sinking is used, and substantial thermal gradients can develop across the part. Where stainless steel is exposed to a large heat flux during wafer processing, particularly in a low pressure environment, control of temperature rise over the entire area of the part is difficult, even when one end of the shield has good a thermal connection to a heat sink. This is typical because providing a heat sink along the entire length of a part is usually impractical.

Aluminum is a good thermal conductor and can be used for many chamber parts, but for parts such as chamber shields, its softness requires the shield to be much thicker than where stainless steel is used. Alloying to increase the strength of aluminum significantly reduces its thermal conductance. For example, 6061-T6 Al, a common alloy, has only 70 to 80% of the thermal conductance of pure aluminum. In addition, for tools that deposit metals, acid is typically used for cleaning during the shield recycle process, and the aluminum of the shield itself etches along with the deposited material, severely reducing shield life. Magnesium, also a good thermal conductor, has the same mechanical and recycling problems as aluminum. Beryllium has an excellent strength to weight ratio, has a thermal conductivity similar to that of aluminum, and resists etching in some acids, but unfortunately costs about four times the price of silver. The mechanical properties of other materials that are reasonable thermal conductors, such as tungsten or molybdenum, make them expensive to process. The softness of copper, silver, and gold which are the best thermal conductors, require parts to be thick so the part does not warp under its own weight. The added thickness required causes large parts to exceed ergonomic weight limits given the large mass of differences between these materials and aluminum. Additionally, the raw material cost of gold and silver limits their use to very small parts.

Accordingly, there remains a need for more effective and efficient control of the temperature of processing chamber parts.

### SUMMARY OF THE INVENTION

According to principles of the present invention, chamber parts are clad with a material having a higher thermal conductivity than that of the material of which the base part is made. The cladding is configured to promote control the base part's temperature.

More particularly, in accordance with preferred embodiments of the invention, a processing chamber part is provided with a cladding layer or layers having a substantially higher thermal conductivity than that of the part, which itself could be composed of multiple layers. The cladding material preferably has the highest practical thermal conductivity, has a low raw material cost, and is able to be applied to the base shield material economically, to facilitate the reconditioning and recycling of the part.

The Noble metals copper, silver, and gold have the highest thermal conductivity of all metals. Of these three, copper has the lowest raw material cost by a wide margin. Although copper is the most economical cladding, the invention is not limited to this material, which need not even be a metal.

In preferred embodiments, the coating is on the order of 0.5 to 2 millimeters thick, and at least approximately 1 mm thick. It is preferable, but not absolutely necessary, for the cladding to be of high purity and density.

A preferred method for applying a thick pure cladding is the cold spray technique, which is a commercially available process. The basis of the technique is thermal evaporation of the cladding material in an inert ambient and using the inert ambient gas to carry the evaporated cladding material vapor to the part. The inert ambient gas, which is typically argon, prevents oxidation of the evaporated cladding material. With a low deposition rate and lack of clusters, a dense, pure coating results. Cladding purity exceeding 99% can be achieved with this technique.

Other methods of applying claddings exist, and the invention is not limited to application by cold spray. Any effective cladding technique may be used. Electroplating and twin wire arc spray (TWAS) are examples.

The base part, clad according to the present invention, has the ability to be recycled many times and has enough mechanical strength for a thin shell to resist deformation under its own weight. Further, the part is formed of materials having compatibility with the processing environment.

Although the invention is most effective for large parts, it covers use of claddings for temperature control of small parts as well. While the invention is particularly useful for base parts formed of metal, it is not limited to metal and can apply to non-metals as well, and combinations of metals and non-metals.

A cladding of high thermal conductivity, applied to a poor thermal conductor base layer, according to the invention, significantly reduces the temperature of the composite part in regions far from where the part is connected to a heat sink.

The cladding, according to certain embodiments of the invention, is formed of a Nobel metal at least 0.5 mm thick. Where the part is a hollow refractory metal cylindrical chamber shield, the cladding may be located on the exterior of the hollow cylinder for temperature control of the composite part while retaining the conditioned inner surface of the refractory metal base layer to collect deposits. The interior of the part may itself have a coating whose purpose is to improve adhesion of any subsequent deposition received in a processing module or environment.

In a preferred embodiment of the invention, the Noble metal is copper, the base refractory material is a thin shell of stainless steel, and the interior coating, if applied, is twin wire arc spray aluminum. The choice of stainless steel provides for structural integrity of the composite part, the ability to recycle the base material, and ease of cleaning of the base material.

Another preferred embodiment of the invention is a Nobel metal coating on the interior of the hollow refractory metal cylinder for temperature control of the composite part and improved adhesion of any subsequent deposition from the processing chamber.

Reduced particle production results from a composite part made from a base or substrate material having a low thermal conductivity material that is coated with a material of higher thermal conductivity. The improved temperature control provides for reduced shedding of any subsequently deposited layer.

The invention is especially useful for controlling the temperature of chamber shields that are used to protect chamber walls from deposits in deposition and etching machines, including physical vapor deposition (PVD) modules, chemical vapor deposition (CVD) modules, and etching chambers, where exposure to heat flux may expand the component or portions of the component, causing particle flaking or other problems. The invention also is generally useful in controlling the temperature of other processing chamber components that have a tendency to expand when exposed to heat flux, even where the component is not exposed to material deposits, thereby limiting potentially undesirable expansion or thermal deformation of such components.

These and other objectives and advantages of the present invention will be more readily apparent from the following detailed description.

### BRIEF DESCRIPTION OF THE DRAWINGS

FIG. 1 is a diagram of a processing apparatus embodying principles of the present invention.

FIG. 2 is an enlarged diagram of a portion of the apparatus of FIG. 1.

FIG. 3 is a graph of a temperature profile of a hollow, cylindrical part of FIGS. 1 and 2 during continuous wafer cycling, with the interior exposed to a constant heat source during the rising part of the curves on the graph.

FIG. 4 is a graph comparing analytical and modeled results of the temperature profile at the bottom of the part of FIGS. 1 and 2.

FIG. 5 is a graph of modeled temperature at the top and bottom of the part of FIGS. 1 and 2 as a function of cladding thickness.

### DETAILED DESCRIPTION OF THE DRAWINGS

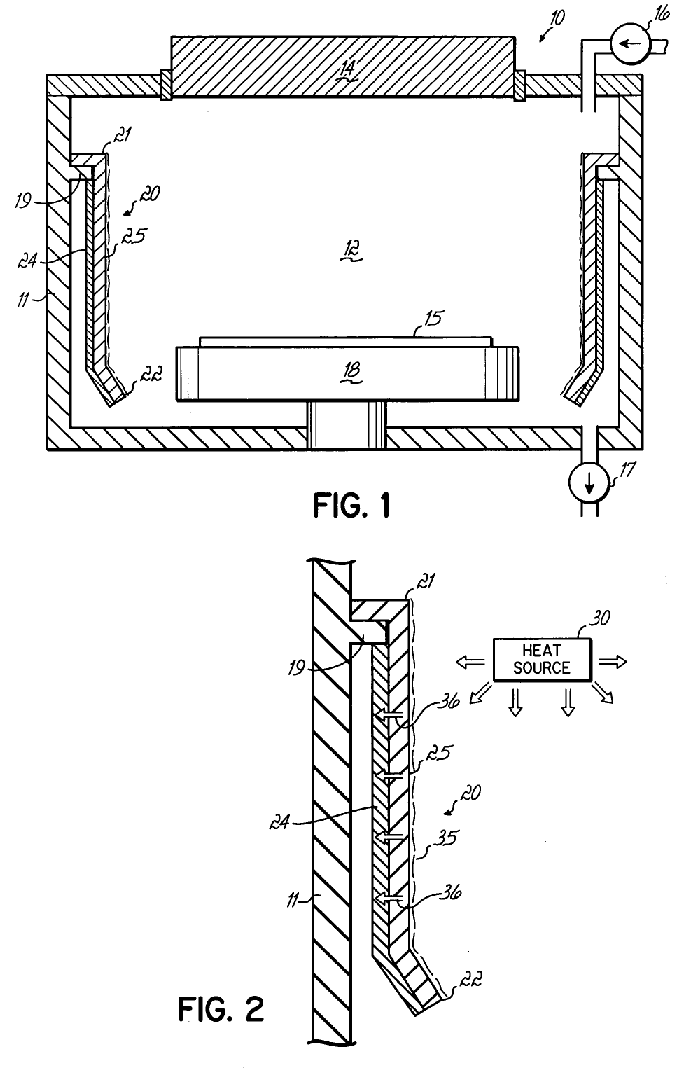

FIG. 1 illustrates a wafer processing apparatus 10 such as a physical vapor deposition or sputter coating apparatus in which semiconductor wafers 15 are processed by application of a metal film (not shown). The apparatus 10 includes a chamber wall 11 that surrounds a processing chamber 12 enclosed within. A lid 13 closes an opening in one end of the chamber 12. A coating material source 14 is illustrated as supported by the lid 13. A processing gas source 16 supplies processing gas into the chamber 12, while a vacuum pump 17 maintains the gas at a vacuum pressure level within the chamber 12. A substrate support 18 within the chamber 12 supports a wafer therein for processing.

A number of parts within the processing chamber 12 are exposed to the process being carried out within the chamber. Typically, many of these parts are placed in the chamber 12 for the purpose of shielding other surfaces from deposition. A chamber shield 20, which is one of several shields, is a part that is typically provided for this purpose. This shield 20, shown as a cylindrical barrel shield, is usually supported at one end 21 thereof on the chamber wall 11 or other intermediate structure 19, which may serve as a heat sink. Another end or portion 22 of the part 20 is usually free and unsupported, allowing for free thermal expansion.

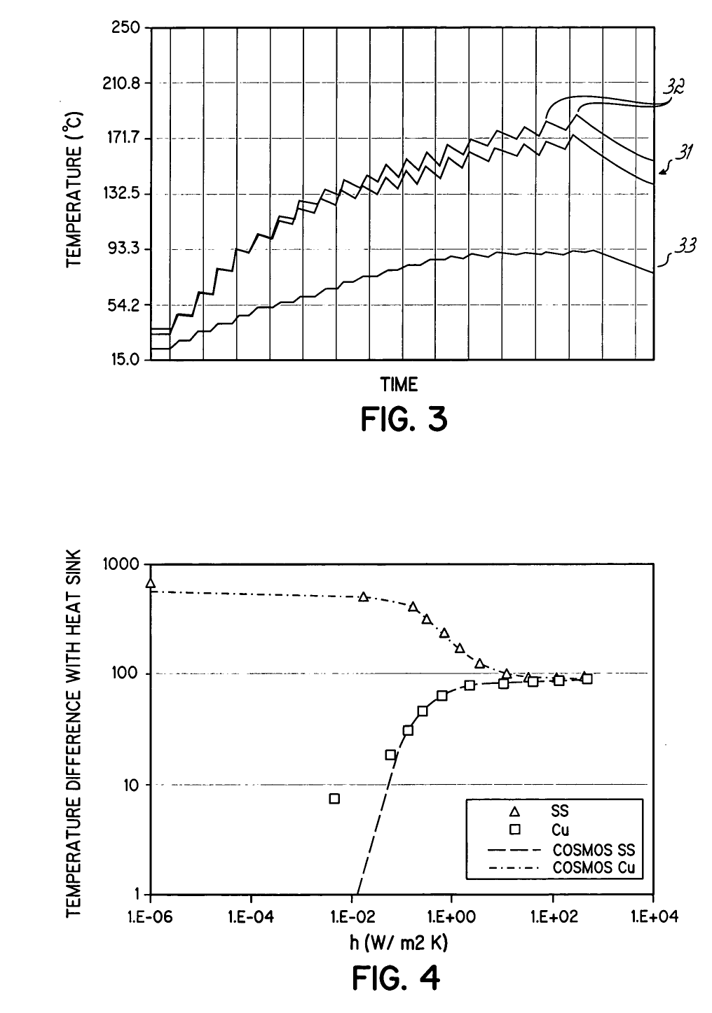

In the course of a coating process, such as, for example, a sputter coating process, within the chamber 12, the center of the chamber 12, which contains an active plasma, is a heat source 30 (FIG. 2) for parts within the chamber 12. A typical temperature profile for a shield, such as the shield 20, under continuous wafer processing is shown as curves 31 in FIG. 3. Saw-tooth oscillations 32 in the temperature of the shield 20 result from exposure of the part 20 to the heat source 30 during wafer processing alternating with cycles of cooling between wafer processes as wafers 15 are being exchanged. It is also seen from FIG. 3 that the average temperature of the shield 20 increases with the number of wafers processed, until the average temperature approaches a steady state. With one end 21 of the shield 20 in thermal contact with a heat sink at 19, the temperature of the shield 20 reaches its highest temperature at its free end 22. At this point the time variation of the average temperature is essentially zero and therefore

$$\frac{\partial T}{\partial t} = 0$$

In accordance with the invention, a cladding of high thermal conductivity material is applied to a poor thermal conductor to significantly reduce the temperature of the composite part in regions far from where the part is connected to a heat sink. As illustrated in FIGS. 1 and 2, a layer 24 of high thermal conductivity metal is clad onto the part 20. In the case of the chamber shield shown, this part 20 is formed of stainless steel, which constitutes a poor thermal conductor base layer 25 of the clad shield 20. With a 1 millimeter layer of copper cladding 24, the temperature of the shield 20 is approximately as shown by the curve 33 in FIG. 3. Where the part 20 is a heat shield, for example, which collects deposits 35 on the inside of its hollow interior facing the chamber 12, the cladding layer 24 is applied on the opposite or outside of the base layer 25, leaving the surface of the base layer 25 to receive the deposits, for which it is better suited than is the cladding 24.

Both an analytical solution to the heat conduction equation and the results of thermal modeling support the effectiveness of the invention. Although the example is for a cylindrical part 20, the analysis is also applicable to parts of other shapes or sizes. In the illustrated example, a hollow bilayer cylinder part 20 is bolted to a ring 19 that makes intimate thermal contact to the chamber wall 11, which approximates an infinite heat sink. The interior of the cylinder formed by the base layer 25 is exposed to a constant, uniform heat flux from heat source 30. The general form of the heat conduction equation without sources or sinks for a position r is:

$$\frac{\partial T}{\partial t} = \frac{1}{ρ {C}_{p}} {∇}^{2} ( kT ) \qquad ( Equation 1 )$$

where ∇² is the Laplacian operator and the variables T and t represent the temperature and time, respectively, ρ is the mass density, Cₚ is the specific heat at constant pressure, and k is thermal conductance. For the illustrated cylindrical shield 20, the inside of the base layer 25 is exposed to a constant, uniform heat flux source, q. The cladding 24 acts as a sink for the base layer 25 of the part 20, and conversely, the base layer 25 of the part 20 acts as a source for the cladding 24. The form of this term is h (Tp-Tc), where h is the heat flux transfer coefficient, assumed to be constant over the applicable temperature range, and the subscripts p and c refer to the base layer 25 of the part 20 and its cladding 25, respectively.

For the temperature range involved, the thermal conductivity of a metals can be taken as constant. The cylinder height is much larger than the width, essentially reducing the problem to propagation of heat in one dimension. The equations describing the thermal conductance for the part 20 having the base layer 25 and the cladding 24 along the length of the cylinder then reduces to Equation 2 for the part, and Equation 3 for the cladding, as follows:

$$\begin{matrix}- {k}_{p} \frac{{\partial }^{2} {T}_{p}}{\partial {x}^{2}} = q - h ( {T}_{p} - {T}_{c} ) & ( Equation 2 ) \\ - {k}_{c} \frac{{\partial }^{2} {T}_{c}}{\partial {x}^{2}} = q - h ( {T}_{p} - {T}_{c} ) & ( Equation 3 )\end{matrix}$$

The thermal conductance k (W/K) is used so that q is the power flux (W/m²).

The boundary conditions for the problem are

$$\frac{\partial T}{\partial t} = 0$$

at x=0 (free end 22), where the part 20 is thermally floating, and T=0 at x=L (fixed end 21), where the part is connected to the infinite heat sink. The general solutions for Tₚ and T_{c} are:

$$\begin{matrix}{T}_{p} = ( \frac{{L}^{2} - {x}^{2}}{2 ( {k}_{p} + {k}_{c} )} + \frac{{k}_{c}^{2}}{{h ( {k}_{p} + {k}_{c} )}^{2}} ( 1 - \frac{cosh ( x / λ )}{cosh ( L / λ )} ) ) q & ( Equation 4 ) \\ {T}_{c} = ( \frac{{L}^{2} - {x}^{2}}{2 ( {k}_{p} + {k}_{c} )} + \frac{{k}_{c} {k}_{p}}{{h ( {k}_{p} + {k}_{c} )}^{2}} ( 1 - \frac{cosh ( x / λ )}{cosh ( L / λ )} ) ) q & ( Equation 5 )\end{matrix}$$

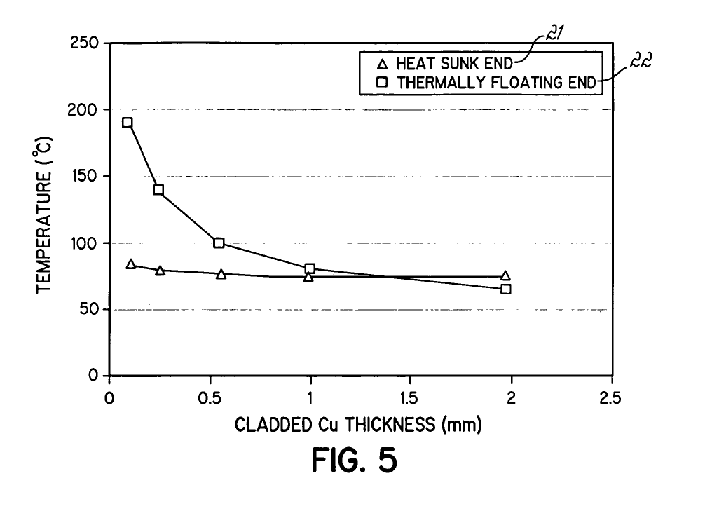

It can be seen that in the limit of large h, where good thermal contact exists between the cladding 24 and base layer 25 of the part 20, and where k_{c}>>kₚ, that Tₚ approaches T_{c}, and the temperature of the composite part 20 is controlled by the thermal conductivity of the cladding 24. FIG. 4 shows this, with good agreement between data points calculated from the analytical expressions of Equation 4 and Equation 5 and the curves that are the result of a commercial thermal simulation model, over a wide range of h. This agreement gives good confidence that a model can be used to accurately simulate the temperature of the composite piece 20. FIG. 5 shows the modeled temperature at the ends 21 and 22 of the shield as a function of the thickness of the cladding 24 for copper cladding on a stainless steel base layer 25 of a hollow cylinder chamber shield 20 with a thickness of 2 mm and shield height to thickness ratio of approximately 97. A heat flux of 1500 W/m² is used for the model and the copper cladding 24 is assumed to have the thermal conductivity bulk value of 390 W/m K. It is seen that once the cladding thickness exceeds about 1 mm, the temperature varies little along the length of the part 20.

The invention has been described in the context of exemplary embodiments. Those skilled in the art will appreciate that additions, deletions and modifications to the features described herein may be made without departing from the principles of the present invention.

1. A method of controlling the temperature of a chamber component having a tendency to expand when exposed to heat flux during processing and formed of a base layer having a relatively low thermal conductivity that is in contact with a heat sink at at least one area thereof, the method comprising:
cladding the base layer, across a side thereof and into thermal contact with the heat sink, with a layer of relatively high thermal conductivity material that has a higher thermal conductivity than the base layer.

2. The method of claim 1 wherein:
the cladding includes applying the layer of relatively high thermal conductivity material on a side thereof opposite a side exposed to the heat flux.

3. The method of claim 1 where the component is exposed to material deposits during at least one of a physical deposition process, a chemical deposition process, and an etching process, wherein:
the cladding includes applying the layer of relatively high thermal conductivity material on a side thereof opposite a side exposed to the material deposits.

4. The method of claim 1 wherein:
the cladding includes applying the layer of relatively high thermal conductivity copper to the base layer.

5. The method of claim 1 wherein:
the cladding includes applying to the base layer the layer of the relatively high thermal conductivity material at a thickness of at least approximately 1 millimeter.

6. The method of claim 1 wherein the component is a chamber shield and wherein:
the cladding includes applying the layer of the relatively high thermal conductivity material to cover a side of the shield facing away from the center of the chamber and extending from the heat sink to a remote end of the shield.

7. The method of claim 1 wherein the component is a chamber shield having a base layer formed of stainless steel, and wherein:
the cladding includes applying a layer of copper and is applied to a thickness at least approximately 1 millimeter to cover a side thereof facing away from the center of the chamber, extending from the heat sink to a remote end of the shield.

8. The method of claim 1 wherein
the cladding includes cold spraying the layer of relatively higher thermal conductivity material onto the base layer.

9. A component for installation in a wafer processing chamber in a location where it is likely to be exposed to heat flux during processes performed in the chamber, the component comprising:
a base layer having a relatively low thermal conductivity;
a surface configured for thermal contact with a heat sink of the chamber;
a remote portion thereof remote from the heat sink;
a layer of relatively high thermal conductivity material that has a higher thermal conductivity than the base layer cladding a surface thereof extending from the heat sink to the remote portion.

10. The component of claim 9 wherein:
the layer of relatively high thermal conductivity material is formed of a Nobel metal.

11. The component of claim 9 wherein:
the layer of relatively high thermal conductivity material is formed of copper.

12. The component of claim 9 wherein:
the base layer is formed of stainless steel; and
the layer of relatively high thermal conductivity material is formed of copper.

13. The component of claim 9 wherein:
the layer of relatively high thermal conductivity material is formed of a Nobel metal at least approximately 0.5 millimeter thick.

14. The component of claim 9 wherein:
the layer of relatively high thermal conductivity material is formed of copper at least approximately 0.5 millimeter thick.

15. The component of claim 9 wherein:
the base layer is formed of stainless steel; and
the layer of relatively high thermal conductivity material is formed of copper at least approximately 0.5 millimeter thick.

16. The component of claim 9 wherein:
the base layer is formed of a refractory metal; and
the layer of relatively high thermal conductivity material is formed of copper at least approximately 0.5 millimeter thick.

17. A wafer processing apparatus comprising a vacuum chamber having therein the component of claim 9.

18. A chamber shield for installation in a wafer processing chamber to protect walls thereof from deposits of material from processes performed in the chamber, the shield comprising:
a hollow cylindrical base layer formed of a refractory metal having an inner surface adapted to enhance adhesion of the material from the processes;
a proximate end of the cylinder being configured for mounting the shield to a wall of the chamber in thermal contact with a heat sink of the chamber;
a remote end of the cylinder being remote from the heat sink; and
a layer of Nobel metal having a higher thermal conductivity than the base layer and cladding the outer surface of the base layer from the proximate end to the remote end.

19. The shield of claim 18 wherein:
the hollow cylindrical base layer has an inner surface having a twin arc spray coating of aluminum thereon adapted to enhance adhesion of the material from the processes.

20. The shield of claim 18 wherein:
the layer of Nobel metal is a cold sprayed layer having a purity of approximately 99 percent.

21. The shield of claim 18 wherein:
the layer of Nobel metal is a copper.

22. The shield of claim 18 wherein:
the base layer is formed of stainless steel.

23. A wafer processing apparatus comprising a vacuum chamber having therein the shield of claim 18.
